(19) United States
(12) Patent Application Publication
(10) Pub. No.: US 2026/0004311 A1
(43) Pub. Date: Jan. 1, 2026

(54) PHOSPHORESCENT AUTHENTICATION DEVICES, SYSTEMS, AND METHODS

(71) Applicant: Spectra Systems Corporation, Providence, RI (US)

(72) Inventor: Nabil Lawandy, Saunderstown, RI (US)

(21) Appl. No.: 18/755,632

(22) Filed: Jun. 26, 2024

(51) Int. Cl. G06Q 30/018

(52) U.S. Cl. CPC G06Q 30/0185; G01N 21/6408; G07D 7/0056; G07D 7/1205; G07D 7/205

(57) ABSTRACT

A system and associated methods for authenticating an item including a substrate, the system including a phosphorescent material disposed on or in the substrate and capable of emitting radiation upon excitation by ambient electromagnetic radiation, and a photoauthentication device capable of being disposed in contact with the substrate, the photoauthentication device including a camera configured to detect or measure the emitted radiation, where, in connection with detecting or measuring the emitted radiation, the photoauthentication device is in static contact with the substrate and the camera is disposed over a portion of the phosphorescent material emitting the emitted radiation.

### TECHNICAL FIELD

The present application generally relates to devices, apparatus, systems and methods for authenticating items. Specifically, the present application relates to using a phosphorescent label or phosphorescent materials in conjunction with a camera, such as a smartphone camera, for authenticating items.

### BACKGROUND OF THE INVENTION

Counterfeiting is a growing business and economic concern. Various products and items are subject to counterfeiting. For example, tax stamps for products such as liquor and tobacco, apparel, footwear, ink cartridges, currency, automotive parts, and electronics can all be subject to counterfeiting. Counterfeit products are often difficult to detect and are typically of inferior quality. Counterfeit products have an adverse impact on both consumers and manufacturers, and could even be harmful and/or dangerous to unsuspecting consumers.

Manufacturers attempt to discourage and prevent counterfeiting through various techniques. For example, some manufacturers of products targeted by counterfeiters have utilized specific markings, holograms, stamps, or other features on their products. Nevertheless, these techniques can typically be circumvented by counterfeiters. Another anti-counterfeiting technique that has been the use of radio frequency identification (RFID) tags; however, RFID tags can be expensive, and the technology needed to identify the data transmitted by each RFID tag is not readily available to consumers.

Many consumers, however, now carry smartphones with cameras that may be used to take photographs, videos, read codes, provide measurements, and otherwise interact with and learn about their surrounding environment.

Accordingly, there is a need for cost-effective and accurate authentication of products that is accessible and easy to use by consumers, while being difficult for counterfeiters to circumvent.

### SUMMARY OF THE INVENTION

In general, in one aspect, the invention features a system for authenticating an item including a substrate, the system including a phosphorescent material disposed on or in the substrate and capable of emitting radiation upon excitation by ambient electromagnetic radiation, and a photoauthentication device capable of being disposed in contact with the substrate, the photoauthentication device including a camera configured to detect or measure the emitted radiation, where, in connection with detecting or measuring the emitted radiation, the photoauthentication device is in static contact with the substrate and the camera is disposed over a portion of the phosphorescent material emitting the emitted radiation.

Implementations of the invention may include one or more of the following features. The emitted radiation from the phosphorescent material may have a spectral signature and the camera may be configured to detect or measure the spectral signature, and the phosphorescent material may include at least a first phosphorescent material and a second phosphorescent material. The spectral signature may include a spectral intensity at a first wavelength and a spectral intensity at a second wavelength to define a measured code. The measured code may be compared to a predetermined code to determine authentication. The photoauthentication device may be a smartphone or a tablet. The camera of the smartphone or the tablet may communicate with a display of the smartphone or the tablet such that visible radiation of the emitted radiation is visible on the display. The camera of the smartphone or the tablet may operate in a video mode to measure a time response of the emitted radiation. The camera may communicate with an application to verify the authenticity of the item. A light source on the smartphone or the tablet may include a light source for generating the ambient electromagnetic radiation. The phosphorescent material may have a decay time, and the camera may be capable of functioning in a video mode for detecting or measuring the emitted radiation over at least a portion of the decay time when the photoauthentication device is disposed over the portion of the phosphorescent material emitting the emitted radiation to block the ambient electromagnetic radiation. The emitted radiation from the phosphorescent material may have a spectral signature and the spectral signature may include spectral intensities for a first wavelength and a second wavelength at a first time in the decay time and spectral intensities for the first wavelength and the second wavelength at a second time in the decay time. An ultraviolet radiation absorber may be combined with the phosphorescent material, where the ultraviolet absorber avoids or prevents detection of the emitted radiation from the phosphorescent material by an ultraviolet radiation source. The phosphorescent material may be disposed in a fiber or planchette embedded in the substrate. The substrate may be disposed on or in the item or a label on the item.

In general, in another aspect, the invention features a method for authenticating an item including a substrate, including irradiating the substrate with ambient electromagnetic radiation, the substrate including a phosphorescent material configured to emit radiation upon excitation by the ambient electromagnetic radiation, and detecting or measuring, with a camera of a photoauthentication device, the emitted radiation from the phosphorescent material, where, in connection with detecting or measuring the emitted radiation, the photoauthentication device is in static contact with the substrate and the camera is disposed over a portion of the phosphorescent material emitting the emitted radiation.

Implementations of the invention may include one or more of the following features. The emitted radiation from the phosphorescent material may have a spectral signature and the camera may be configured to detect or measure the spectral signature. The phosphorescent material may include at least a first phosphorescent material and a second phosphorescent material. The phosphorescent material may have a decay time and the method may further include detecting or measuring the emitted radiation over at least a portion of the decay time when the photoauthentication device is disposed over the portion of the phosphorescent material emitting the emitted radiation.

In general, in another aspect, the invention features a method for authenticating an item including a substrate, including irradiating the substrate with ambient electromagnetic radiation, the substrate including a phosphorescent material configured to emit radiation having a spectral signature with a decay time upon excitation by the ambient electromagnetic radiation, and detecting or measuring, with a camera of a photoauthentication device, the emitted radiation from the phosphorescent material during the decay time, generating, with a computing device of the photoauthentication device, a code based on the spectral signature, and comparing, with the computing device of the photoauthentication device, the code to a predetermined reference code, where, in connection with detecting or measuring the emitted radiation, the photoauthentication device is in static contact with the substrate and the camera is disposed over a portion of the phosphorescent material emitting the emitted radiation when the emitted radiation is detected or measured to block the ambient electromagnetic radiation.

Implementations of the invention may include one or more of the following features. The phosphorescent material may include at least a first phosphorescent material and a second phosphorescent material.

### BRIEF DESCRIPTION OF THE DRAWINGS

FIG. 1A is an illustration of an exemplary phosphorescent label according to certain exemplary embodiments of the present invention;

FIG. 1B is an illustration of an exemplary phosphorescent label according to certain exemplary embodiments of the present invention;

FIG. 1C is a diagram of an exemplary phosphorescent label according to certain exemplary embodiments of the present invention;

FIG. 1D is a diagram of an exemplary phosphorescent label according to certain exemplary embodiments of the present invention;

FIG. 1E is a diagram of an exemplary phosphorescent label according to certain exemplary embodiments of the present invention;

FIG. 2A is an illustration of an exemplary phosphorescent label according to certain exemplary embodiments of the present invention;

FIG. 2B is an illustration of an exemplary phosphorescent label according to certain exemplary embodiments of the present invention;

FIG. 2C is a diagram of an exemplary phosphorescent label according to certain exemplary embodiments of the present invention;

FIG. 2D is an illustration of an exemplary spatial pattern of an exemplary phosphorescent label according to certain exemplary embodiments of the present invention;

FIG. 3 is a diagram of an exemplary phosphorescent authentication system according to certain exemplary embodiments of the present invention;

FIG. 4A is a graph showing certain representative spectral characteristics of an exemplary radiation source according to certain exemplary embodiments of the present invention;

FIG. 4B is a graph showing certain representative spectral characteristics of exemplary emitted radiation according to certain exemplary embodiments of the present invention;

FIG. 4C is a graph showing certain representative spectral characteristics of exemplary emitted radiation according to certain exemplary embodiments of the present invention;

FIG. 5A is a flow diagram of an exemplary method according to certain exemplary embodiments of the present invention;

FIG. 5B is a flow diagram of an exemplary method according to certain exemplary embodiments of the present invention;

FIG. 6 is an illustration of color variation that may be produced by exemplary phosphorescent material within an exemplary phosphorescent stamp according to certain exemplary embodiments of the present invention;

FIG. 7 is a diagram of an exemplary phosphorescent authentication system according to certain exemplary embodiments of the present invention; and

FIG. 8 illustrates an exemplary hue vs. saturation chart.

### DETAILED DESCRIPTION OF THE PREFERRED EMBODIMENTS

Exemplary embodiments of the present invention are generally directed to devices, apparatus, systems, and methods for authentication using phosphorescence. Specifically, exemplary embodiments of the present invention provide a label including a phosphorescent material and associated detecting/sensing mechanisms that may be used to authenticate an item to which the label is affixed. Although the exemplary embodiments of the present invention are primarily described with respect to authentication and/or preventing counterfeiting, it is not limited thereto, and it should be noted that the exemplary phosphorescent label may be used to encode other types of information for other applications. Further, the exemplary embodiments of the present invention may be used in conjunction with other authentication measures, e.g., holograms, watermarks, and magnetic encoding.

An exemplary embodiment of the present invention provides a label including a phosphorescent material and a sensor to image and/or read an emitted spectral signature from the label. According to an exemplary embodiment of the present invention, the phosphorescent label includes a phosphorescent material, e.g., one or more phosphors. The phosphorescent material may be configured to absorb an incident radiation and to emit an emitted radiation having a spectral signature after removal of the source of the incident radiation. According to certain exemplary embodiments of the present invention, the spectral signature may include spectral intensities at certain wavelengths, and the phosphorescent material may be selected and configured such that the emitted radiation has known intensities at specific wavelengths. For example, the phosphorescent material may be excited by irradiating the phosphorescent material with an incident radiation such as, e.g., ambient and/or visible light, which is absorbed by the phosphorescent material, and the phosphorescent material may then emit radiation having a spectral signature, such as each of red (“R”), green (“G”), and blue (“B”) light at known spectral intensities. In exemplary embodiments, the number of phosphors (N), with each employed phosphor emitting a unique wavelength, provides 2^{N}−1 unique combinations of wavelengths to use in producing a desired spectral signature. In embodiments of the present invention, the phosphorescent material includes a single phosphor or a mixture of phosphors, in which each phosphor in the mixture emits at a different wavelength and has a different decay time. In certain embodiments, such phosphors, particularly those having a long decay time (e.g., 1 second or greater), may be combined with other fluorescent or short decay emitters capable of absorbing radiation and emitting radiation having long decay wavelengths and emitting radiation at different wavelengths in order to provide further unique combinations of RGB spectra and consequently spectral signatures and codes. In particular embodiments, the phosphorescent materials with long decay times, and at least first and second phosphorescent materials may be combined to provide unique spectral and temporal signatures as the first and second phosphorescent materials experience decay.

Alternatively, the phosphorescent material may be applied in a specific spatial pattern, and the spectral signature may include spectral intensities emitted by the patterned phosphorescent material. The spectral signature, which may include, e.g., spectral intensities at the particular wavelengths or a patterned spectral signature, can effectively be used as a code. This code, for example, may be used to authenticate the item to which the label is attached. This code can be created with any number of selected spectral intensities and, thus, more complex and intricate codes can be created by using a greater number of selected spectral intensities at particular wavelengths. Thus, the phosphorescent material may be specifically selected for the incident radiation and the desired spectral intensities in the emitted radiation. According to exemplary embodiments of the present invention, the desired spectral intensities may include the particular wavelengths and the relative and absolute amplitudes of the spectral intensities at the particular wavelengths.

The phosphorescent material may include or be combined with an absorbing and reemitting material, e.g., a dye, to create an additional level of security and protection to the phosphorescent material and/or phosphorescent label. In preferred embodiments, the absorbing and reemitting material is either mixed in with the phosphorescent material or disposed on top of the phosphorescent material. The dye, which may have a short decay time for radiation emitted thereby in comparison to the phosphorescent material, may absorb radiation emitted by the phosphorescent material itself and be excited and reemit radiation of a different wavelength, i.e., having a different color, throughout the decay period of the phosphorescent material. Additionally, the phosphorescent material may be coated with a fluorescent material capable of absorbing radiation emitted by the phosphorescent material and shifting the emission spectrum to that of the fluorescent material. In certain embodiments, the phosphorescent material may be combined with an ultraviolet radiation absorber, such that the ultraviolet absorber avoids or prevents detection of the emitted radiation from the phosphorescent material by an ultraviolet radiation source. Similarly, the phosphorescent material may be disposed within a fiber, planchette, or other shaped inclusion that includes the aforementioned fluorescent material therein or thereon. A plurality of these inclusions may be included in or on a substrate, e.g., a paper substrate or a polymer substrate. The phosphorescent material may be applied to or embedded in any secondary material that allows incident radiation to reach and affect, e.g., excite, the phosphorescent material.

Preferably, the phosphorescent material has a long decay time during which emitted radiation is emitted, e.g., greater than 1 second. According to certain exemplary embodiments of the present invention, the phosphorescent material may have a decay time of any length, such as a tenth of a second, a quarter of a second, half a second, one second, or multiple seconds, e.g., 2, 3, 4, 5, or more seconds. In one preferred embodiment, the decay time is at least a quarter of a second. The long decay time would enable a user sufficient time to scan or image the phosphorescent label during the decay time so that the user can obtain a measurement of the spectral intensities at particular wavelengths of the emitted radiation. In particular embodiments, phosphor taggants are utilized as the phosphorescent material, with preferred embodiments including phosphor taggants having long emission decay times and which are excitable by ambient light and/or visible light.

Further, the phosphorescent material may be applied to virtually any surface or material, thus allowing the use of the exemplary phosphorescent label or substrate for a wide range of applications. Accordingly, the exemplary phosphorescent label or substrate is not limited to flat and/or smooth surfaces and can be used in or on flexible and non-flexible materials such as fabrics, paper, polymers, board stock, and other substrates, and may be incorporated onto or in the item itself, the label, the packaging, or a combination thereof. A polymer may include biaxially-oriented polypropylene (BOPP) and the like. According to certain exemplary embodiments, phosphorescent material is disposed in or on two or more substrates, such as both a paper substrate and a polymer substrate, that together provide a spectral signature upon excitation with incident radiation. An example of such an embodiment is a cigarette box and its plastic wrapping, both of which contain different phosphorescent materials, and which together are capable of producing a spectral signature. The spectral signature in this example would indicate whether there had been tampering with the product and/or its packaging. According to certain other exemplary embodiments, the coating can be disposed under the surface of the label and may be excited and scanned and/or imaged through the surface of the label.

In an exemplary embodiment, the phosphorescent material may be applied to or embedded in a substantially flat surface of an object. Further, the sensor may be a camera sensor of a camera embedded within or attached to a smartphone. The smartphone may operate using any operating system, e.g., IOS or ANDROID, that enables the smartphone to take photographs or videos using the camera. In operation, after the phosphorescent material is applied to or embedded within the substantially flat surface, the phosphorescent material may then be excited with incident radiation, i.e., ambient electromagnetic radiation. After the excitation, the camera may be placed upon or pressed against the substantially flat surface, preferably in static contact with said surface, such that all or most of the incident radiation is blocked from interacting with a relevant portion of the phosphorescent material. The phosphorescent material associated with this portion may then emit radiation that is captured by the camera sensor and made visible through a viewing lens or display screen associated with the camera sensor, e.g., a display screen of the smartphone. In this way, a consumer may use his or her smartphone to quickly and effectively verify the presence of the phosphorescent material, and thereby authenticate the object to which the phosphorescent material is applied.

In a further embodiment, the smartphone may utilize a software application to authenticate the presence of phosphorescent material. In operation, the phosphorescent material may be applied to or embedded within a desired surface of an object. The phosphorescent material is excited with incident radiation, i.e., ambient electromagnetic radiation, whereupon the camera may be placed against at least a portion of the phosphorescent material. The camera sensor detects the radiation produced by this portion of the phosphorescent material, and sends data from the detected radiation to the software application. The software application may then process the data, either using computational hardware within the smartphone or via a cloud server connection, to authenticate the spectral signature associated with the phosphorescent material. The software application may then produce a code or value associated with the phosphorescent material and provide that code or value to a user of the smartphone to verify the presence of the phosphorescent material, and thereby authenticate the object to which the phosphorescent material is applied. The data received by the software application may be in the form a still image or a video. Where video is provided to the software application, the software application may analyze the timing and pattern of decay of the phosphorescent material to authenticate the phosphorescent material and the object to which it is applied.

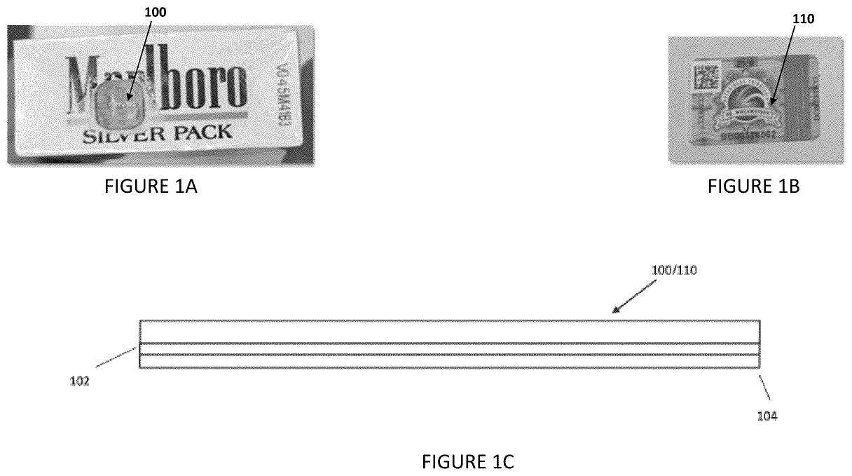

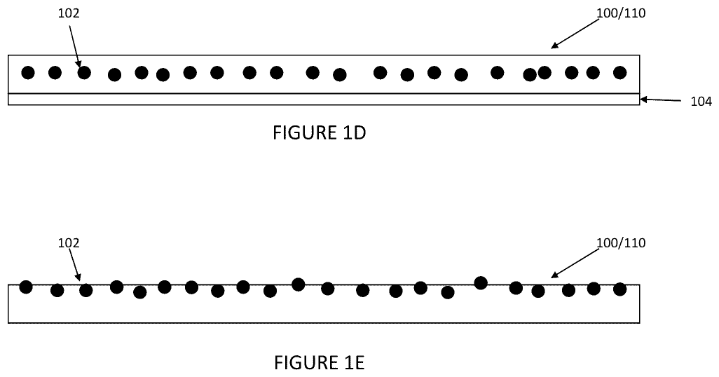

In accordance with exemplary embodiments of the present invention, FIGS. 1A and 1B show exemplary phosphorescent labels 100 and 110 attached to consumer products. Although label 100 is a holographic stamp attached to a cigarette carton, label 100 can be attached to any product or product packaging and can be part of other types of labels, such as, e.g., barcode labels and QR-codes. FIG. 1B shows phosphorescent label 110 as a tax stamp typically affixed to a tobacco product. As with phosphorescent label 100, phosphorescent label 110 can be incorporated onto other labels, such as stamps, on virtually any product. FIG. 1C shows a magnified, generalized cross-sectional view of phosphorescent labels 100 and 110. As shown in FIG. 1C, the phosphorescent material 102 may be applied to the back of the label 100. According to other exemplary embodiments of the present invention, phosphorescent material 102 may be embedded within the label 100 and 110, as seen in FIG. 1D, or impregnated on the surface of the label 100 and 110, as seen in FIG. 1E.

According to certain exemplary embodiments of the present invention, phosphorescent material 102 may include storage phosphors and long decay phosphors containing rare earth metals and transition metals, and various hosts including glasses such as phosphates and aluminosilicates. Further, this phosphorescent material may be added as a coating to any label during the manufacturing process of the label, and in particular, may be included in a binder material attached to the bottom of the label. Preferably, an adhesive, or other affixing element 104 may be applied over the phosphorescent material so that the label can be affixed to a product or a package. Alternatively, phosphorescent material 102 may be applied to the front or top of the label, and a protective coating may be applied over the phosphorescent material 102. According to yet another embodiment of the present invention, phosphorescent material 102 may be directly applied onto or in an item, which may require the item itself, rather than the packaging, to be authenticated. In further embodiments of the present invention, the phosphorescent material 102 may be embedded within a wide variety of materials, including but not limited to inks, dyes, coatings, glass, or polymers, particularly when the phosphorescent material 102 includes storage or long-decay phosphors. Additional embodiments of the present invention provide that the phosphorescent material 102 may be impregnated into a surface layer of materials, such as metals or ceramics.

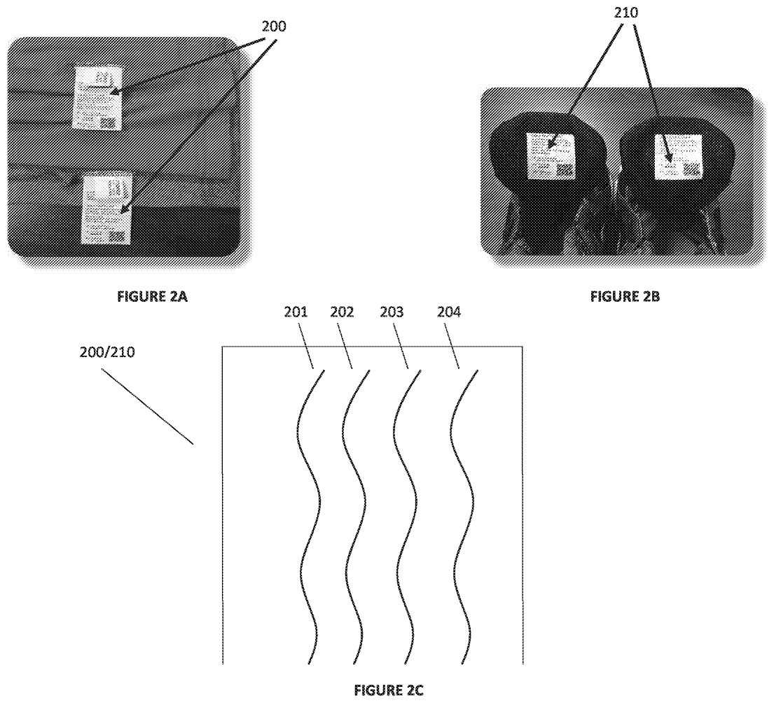

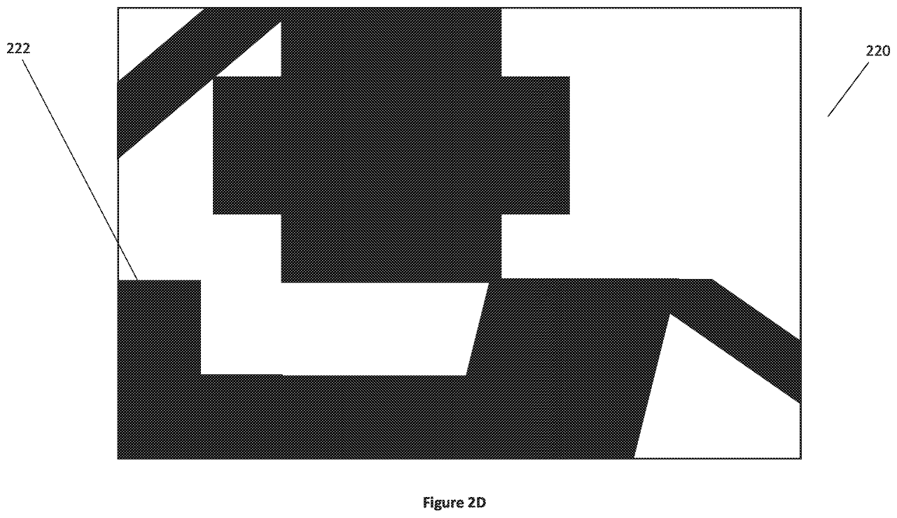

FIGS. 2A and 2B show further exemplary phosphorescent labels 200 and 210 according to certain exemplary embodiments of the present invention. As shown in FIGS. 2A and 2B, phosphorescent labels 200 and 210 are fabric labels that may be attached to certain apparel, such as the phosphorescent label 200 as shown in FIG. 2A, or footwear, such as the phosphorescent label 210 as shown in FIG. 2B.

Similar to phosphorescent labels 100 and 110, phosphorescent labels 200 and 210 may include a phosphorescent material which may be applied as a coating having a printed or spatial pattern onto the fabrics that make up phosphorescent labels 200 and 210. Alternatively, as shown in FIG. 2C, phosphorescent labels 200 and 210 may be constructed from individual threads bearing phosphorescent material. For example, according to an exemplary embodiment of the present invention, at least one of threads 201, 202, 203, and 204 may contain a phosphorescent material, and threads 201-204 can be woven together to create phosphorescent labels 200 and 210. According to certain exemplary embodiments, threads 201, 202, 203, and 204 may all contain the same phosphorescent material. Alternatively, each of threads 201, 202, 203, and 204 may contain a different phosphorescent material, each of which may have differing absorption and emission characteristics. Further, the denier of the threads, e.g., 20-80, may be varied to vary the amount of phosphorescent material that is contained on each thread.

Accordingly, the denier of the threads and the types of phosphorescent material applied to each of the threads may be specifically selected and/or patterned to obtain a spectral and spatial signature, such as specific emission characteristics to yield certain spectral intensities or a spectral and spatial pattern, to create unique codes. For example, threads 201 and 203 may have a certain denier and contain a first type of phosphorescent material, and threads 202 and 204 may have a different denier and contain a second type of phosphorescent material. Alternatively, threads 201-204 may each contain a different type of phosphorescent material. In some embodiments, some of threads 201-204 may not contain any phosphorescent material. Accordingly, any combination or permutation of different deniers and phosphorescent materials may be utilized and patterned to specifically obtain a spectral and spatial signature, such as desired emission characteristics and spectral intensities or a desired spectral and spatial pattern, in the radiation emitted by the phosphorescent labels 200 and 210 in creating unique codes. FIG. 2D shows an exemplary label 220, with the shaded portions representing an exemplary spectral and spatial pattern 222 which may be emitted by phosphorescent labels 200 and 210. In an alternative embodiment, a phosphorescent material that functions in accordance with the present invention may be included in a coating applied directly or indirectly onto a substrate such as a fabric. Such a coating may have additional beneficial properties, such as to protect the substrate or features of the substrate.

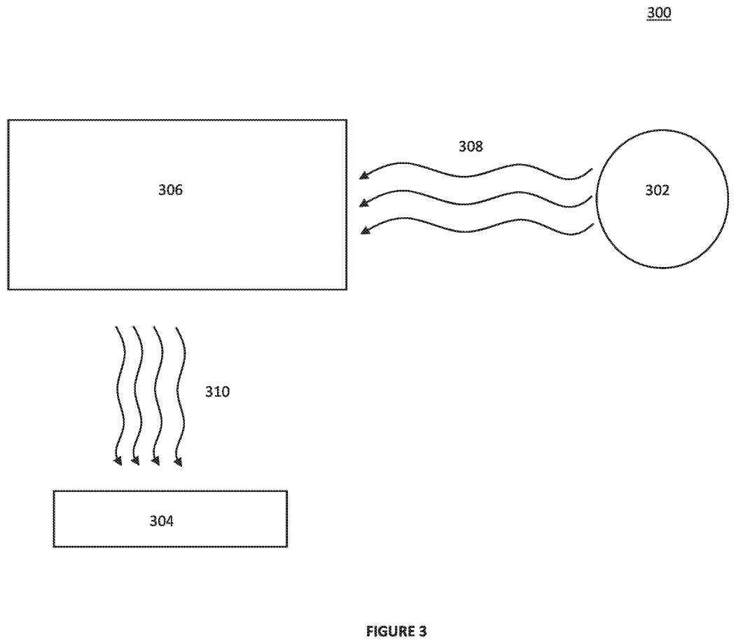

FIG. 3 shows an exemplary system 300 in accordance with exemplary embodiments of the present invention. As shown in FIG. 3, system 300 may include a radiation/excitation source 302, a sensor 304, and a phosphorescent label 306. Radiation/excitation source 302 may be any source supplying radiation 308, such as, e.g., ambient light, visible light, ultraviolet, radio, or microwave, which is to be absorbed by phosphorescent label 306.

Exemplary radiation/excitation sources 302 may include, e.g., sunlight, lighting within a room, a flashlight, a handheld lamp, or any other source of ambient light. The phosphorescent label 306 may re-emit emitted radiation 310 at the same wavelengths or emit emitted radiation 310 at different wavelengths. Phosphorescent label 306 may include any of phosphorescent labels 100, 110, 200, or 210 described herein, and may be attached or affixed to any product or item, e.g., tax stamps, apparel, currency, or footwear, for which authentication may be desirable. Sensor 304 may include any detecting, sensing, imaging, or scanning device that is able to receive, image, and/or measure the spectrum of the radiation emitted by the phosphorescent label 304, such as a photometer or digital camera. According to certain exemplary embodiments of the present invention, radiation/excitation source 302 may include the flash of a digital camera, and sensor 304 may include the optical components and sensors of the digital camera. In one exemplary embodiment, the radiation/excitation source 302 may include the light source of a smartphone or tablet camera, e.g., APPLE IPHONE, APPLE IPAD, SAMSUNG GALAXY or other ANDROID devices, and sensor 304 may include the camera of the smartphone or tablet. Embodiments utilizing a smartphone or tablet camera would not require any additional physical components, such as filter or splitter elements.

In an embodiment utilizing a smartphone or tablet camera, the lens of a smartphone or tablet camera can be put into contact, with or directly up against a surface of the phosphorescent label 306 after radiation/excitation source 302, i.e., ambient electromagnetic radiation, provides excitation radiation 308 to the phosphorescent label 306. The radiation/excitation source 302 may then be removed or otherwise blocked from interaction with the phosphorescent label 306, such as by firmly pressing the lens of the smartphone or tablet camera against all or part of the phosphorescent label 306. After the excitation has been removed or stopped, the spectrum of the emitted radiation is measured with the smartphone or tablet camera placed against phosphorescent label 306. More specifically, in a first example, the radiation/excitation source 302 may irradiate e phosphorescent label 306, the radiation/excitation source 302 may be turned off, the camera or lens may be placed over the irradiated area of phosphorescent label 306, and the camera or lens may measure the emitted radiation. In a second example, the radiation/excitation source 302, i.e., ambient electromagnetic radiation, may irradiate phosphorescent label 306, the smartphone or tablet camera may then be placed over a portion of the irradiated area of label 306, blocking the radiation/excitation source 302 from further irradiating the phosphorescent label 306, and the camera or lens may measure the emitted radiation. In other examples where the emitted radiation is not visible via the camera or the camera cannot sufficiently measure or detect the emitted radiation in response to, e.g., ambient light excitation, radiation/excitation source 302 may briefly irradiate phosphorescent label 306, e.g., for 1 to 5 seconds, with the smartphone or tablet camera then being placed over the irradiated area of label 306. Additionally, the smartphone or tablet camera may be operating in a video mode such that a time response of the emitted radiation may also be measured, as discussed in further detail below.

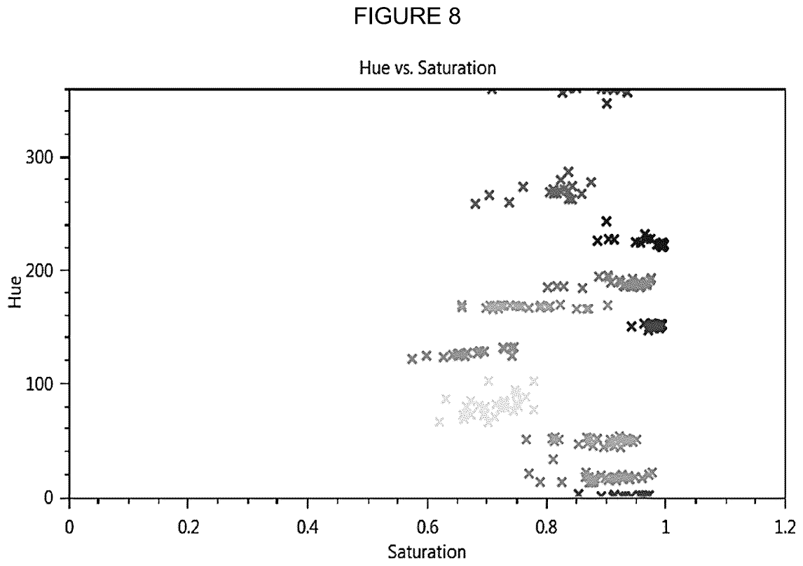

By placing the light source and the lens of the smartphone or tablet camera into contact with or directly up against the surface of phosphorescent label 306, interaction between radiation 308 from the radiation/excitation source 302, i.e., ambient electromagnetic radiation, and the phosphorescent label 306 can be minimized. Any residual background or ambient radiation that is not blocked may be addressed by calibrating the smartphone or tablet camera and its lens to account for such light. In one exemplary embodiment, the smartphone or tablet camera operates in a video mode during the measurement process to measure a time response of the emitted radiation, e.g., ratios relating to spectral intensities for one or more wavelengths may be calculated based on emitted radiation from the phosphorescent material measured at different points during the decay time, permitting temporal characteristics to be incorporated in the analysis of the spectral signature. In one exemplary embodiment, the smartphone or tablet camera is configured to measure color coordinate ratios, hue saturation values, or both, in connection with the analysis of the spectral signature. FIG. 8 shows an example of a hue vs. saturation chart.

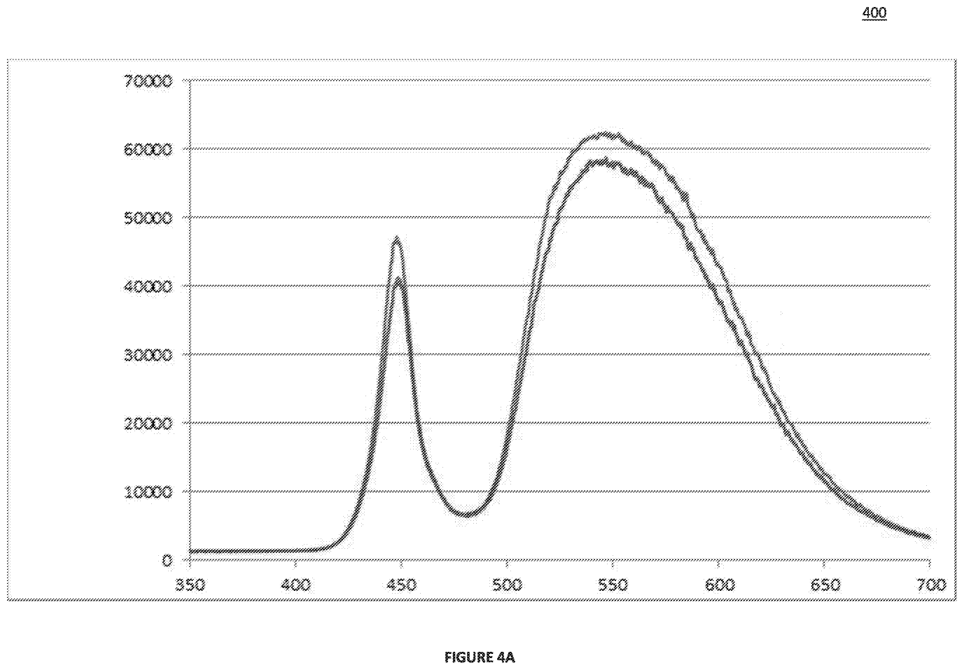

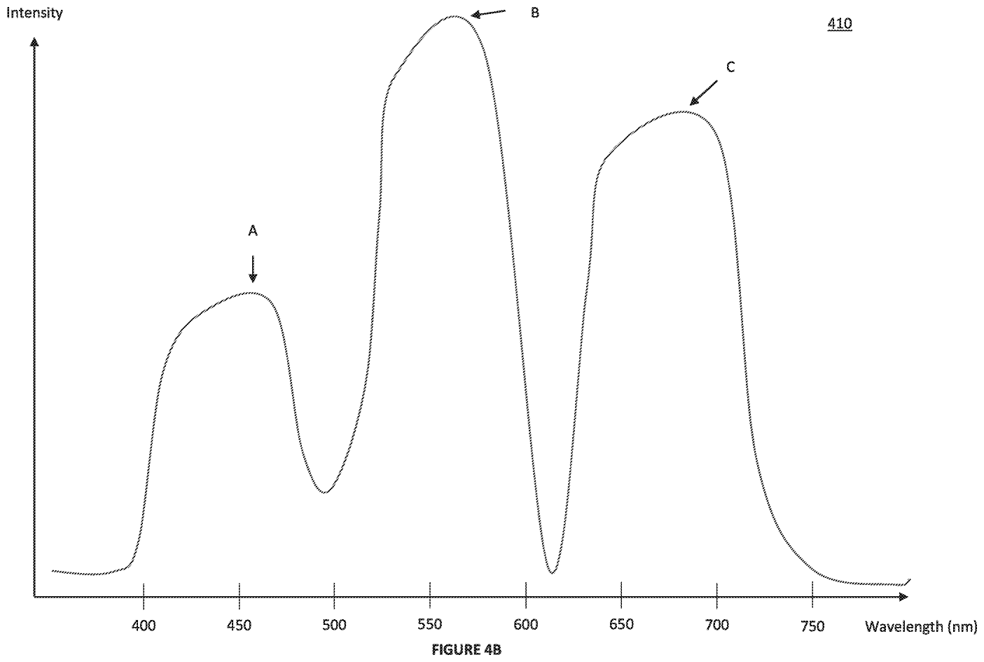

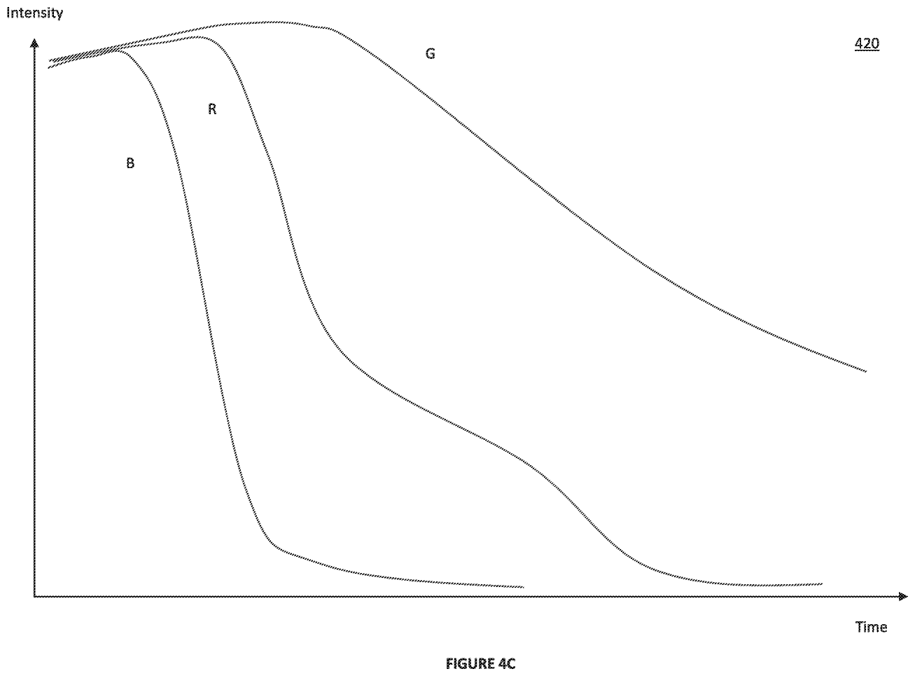

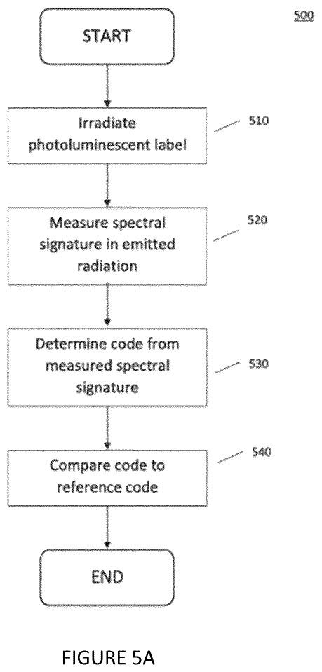

FIGS. 4A, 4B, and 4C are exemplary graphs representing certain representative characteristics of the incident and emitted radiations according to exemplary embodiments of the present invention. The depictions in graphs 400, 410, and 420 are merely representative, and exemplary embodiments of the present invention may employ any variation of decay times, as well as spectral intensity characteristics, such as the number of spectral intensities used, the wavelengths at which the spectral intensities are measured, and the amplitude of the spectral intensities. FIG. 4A shows an exemplary graph 400 of representative spectral intensities of an exemplary incident radiation/excitation source. For example, graph 400 shows the spectral intensities of a smartphone camera light source used in two different modes. As shown in graph 400, the exemplary incident radiation includes higher spectral intensities near the 450 nm and the 550 nm wavelengths, which generally correspond to blue and green light, respectively. It should be noted that the spectral intensities of various light sources may vary widely, and the spectral intensities of the incident radiation absorbed by the phosphorescent label may affect the spectral characteristics of the radiation emitted by the phosphorescent label.

FIG. 4B shows an exemplary graph 410 of representative spectral intensities of emitted radiation that may be used to compose an exemplary code in accordance with exemplary embodiments of the present invention, and FIG. 4C shows an exemplary graph 420 of representative relative decay times of certain wavelengths of the emitted radiation. As shown in FIG. 4B, exemplary graph 410 depicts representative relative spectral intensities of an exemplary spectrum of radiation. According to certain exemplary embodiments of the present invention, the spectral intensities at points A, B, and C, or any other point in the spectrum, may be used to create a unique code encoded on a phosphorescent label. According to certain exemplary embodiments of the present invention, wavelengths in the visible light spectrum or the non-visible light spectrum may be used.

FIG. 4C shows an exemplary graph 420 of representative relative decay times of certain wavelengths of the emitted radiation. As shown in graph 420, each of the wavelengths of radiation in the emitted radiation may decay at a different rate. In view of the variable decay times of certain wavelengths, it may be advantageous to select specific wavelengths based on their respective decay times. For example, wavelengths that have decay times that would allow sufficient time for a user to image and/or measure the radiation emitted by the phosphorescent label are preferable to those that decay quickly and would not provide a user sufficient time to image and/or measure the phosphorescent label.

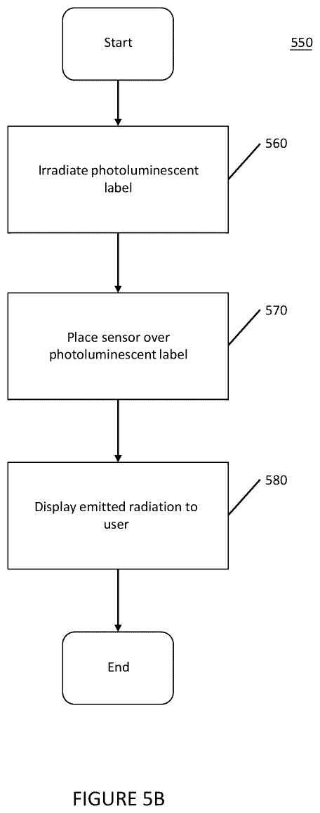

FIG. 5A shows an exemplary flow diagram 500 illustrating an exemplary operation of a phosphorescent system, such as system 300 shown in FIG. 3, for authenticating an item. As described in step 510, a radiation/excitation source 302, i.e., ambient electromagnetic radiation, may irradiate phosphorescent label 306. After the phosphorescent label 306 has absorbed the radiation, the phosphorescent material emits emitted radiation. Accordingly, as shown in step 520, sensor 304 is used to measure the spectral signature in the emitted radiation. As described herein, the spectral signature, which may include a patterned spectrum or a spatial pattern or certain spectral intensities, defines the code encoded in phosphorescent label 306. In step 530, the code is determined from the measured spectral signature. In step 540, the code, which was determined from the measured spectral signature, is compared against reference codes stored in a database. This comparison provides authentication of the item to which phosphorescent label 306 is attached depending on whether or not the deciphered code and the stored reference codes match. Optionally, the process can be repeated to authenticate a subsequent item if the item is found not to be authentic.

FIG. 5B shows an exemplary flow diagram 550 illustrating an exemplary operation of a phosphorescent system, such as system 300 shown in FIG. 3, for authenticating an item. As described in step 560, a radiation/excitation source 302, i.e., ambient light, may irradiate phosphorescent label 306. After the phosphorescent label 306 has absorbed the radiation, the phosphorescent material emits emitted radiation. Accordingly, as shown in step 570, sensor 304, e.g., a smartphone camera sensor, is placed over the phosphorescent label 306. In step 580, the sensor 304 then communicates with a display screen associated with the sensor 304, e.g., a display screen of a smartphone, to display a display of the emitted radiation 310 to a user. This display of the emitted radiation to the user provides a quick and efficient means to authenticate the item to which phosphorescent label 306 is attached depending on whether or not the emitted radiation matches a known coloration of emitted radiation for phosphorescent labels attached to such items.

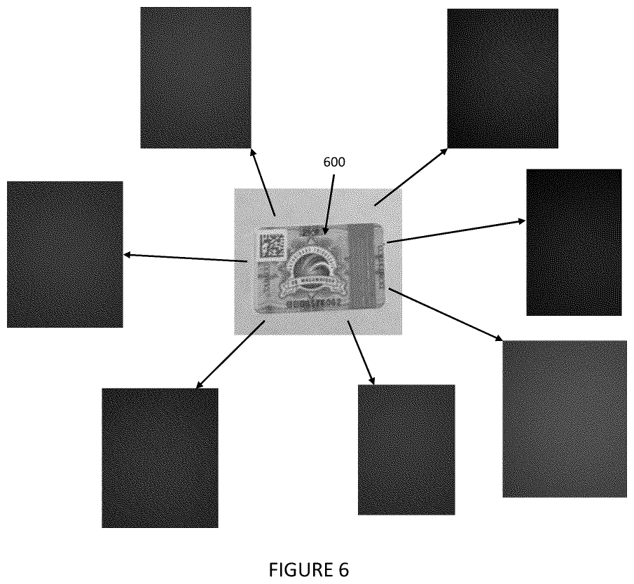

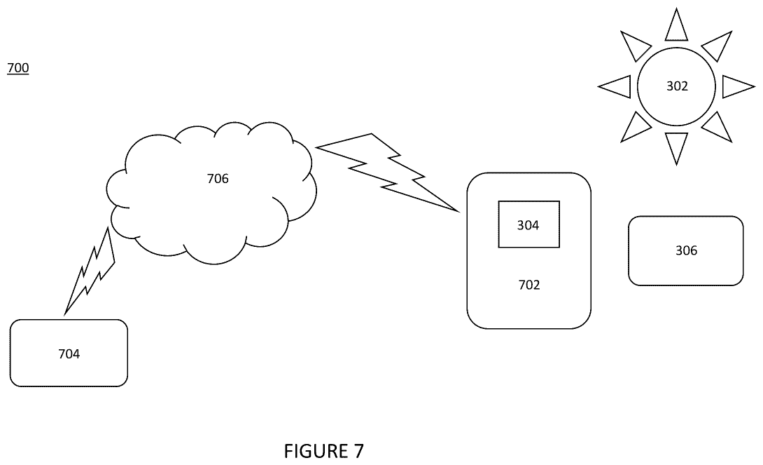

FIG. 6 shows an exemplary phosphorescent label 600 that may be employed as part of an authentication system of the present invention. The phosphorescent label 600 may include phosphorescent materials that exhibit a wide variety of colors, e.g., red, blue, and green, in response to excitation. Further, the phosphorescent materials may be arranged to produce a particular shade of a desired color. Doing so allows a user of a photoauthentication device to quickly and efficiently determine the authenticity of an item with a phosphorescent label 600 attached thereto by, for example, examining the phosphorescent label 600 in accordance with the steps outlined in diagrams 500 and/or 550 of FIGS. 5A and 5B.

FIG. 7 shows an exemplary system 700 that may be employed to authenticate an item using the phosphorescent labels described herein. For example, system 700 includes a computing device 702, which may include sensor 304. Computing device 702 may be any computing device that could incorporate a sensor 304, such as a smartphone, a tablet, or a personal data assistant (PDA). Alternatively, sensor 304 may be standalone devices that operate independent of a computing device. As described herein, the radiation/excitation source 302, i.e., ambient electromagnetic radiation, may irradiate an exemplary phosphorescent label 306, and sensor 304 may measure the radiation emitted by the phosphorescent label, including the spectral signature. The computing device 702 may then determine the code from the measured spectral signature of the radiation emitted by the phosphorescent label 306. Alternatively, this processing may be performed by a remote computing device. Subsequently, the code or the measured spectral signature may be compared to a database of reference codes or spectral signatures. The database of reference codes may be stored locally on the imaging or sensing device or remotely on a separate computing device or cloud storage. As shown in FIG. 7, to complete the authentication, the computing device 702 may compare the code or the measured spectral intensities to the reference codes or spectral signature stored in a database 704. Although FIG. 7 illustrates this comparison being performed via a network 706 to a remote database 704, other embodiments contemplate database 604 being local to computing device 702.

Further, in some embodiments, the item being authenticated may include an identifying label, such as, e.g., a barcode, a QR code, or a magnetic code, to enable correlation of the code or the measured spectral intensities to the item being authenticated. In a particular embodiment where computing device 702 is a smartphone or tablet, the transmission via the network 706 may be done over a cellular data connection or a Wi-Fi connection. Alternatively, this can be performed with a wired connection or any other data transport mechanisms.

In certain embodiments of the present invention where a computing device, such as a smartphone or tablet, is utilized for authenticating an item, a software application may be used to enhance the authentication process. The exemplary application may be configured to be executed on any mobile platform, such as IOS or ANDROID mobile operating system. When the application is run, the software application may provide instructions to a user on properly irradiating or exciting and imaging and/or measuring the phosphorescent label. Once irradiating and scanning of the phosphorescent label is complete, the application may facilitate comparison of the measured spectral signature and/or the measured code with a reference database storing certain reference codes or spectral signatures to authenticate the item. Further, the application may provide a message or other indicator informing the user of the result of the authentication. For example, the application may provide a text, graphical, or other visual indicator on the screen of the smartphone showing the results of the authentication. Alternatively, the application may provide audible and/or tactile indicators conveying the results of the authentication.

One exemplary embodiment of the present invention includes verifying the authenticity of stamps or labels, e.g., tax stamps, using a remote device such as a smartphone. Implementing the detection techniques described herein, an application on the smartphone may be used both to verify the authenticity of stamps and an associated item on which the stamp is affixed. Thus, according to the present invention, a smartphone may be used to authenticate stamped items using a physical signature placed on or embedded in the stamps affixed to the items.

The smartphone application for authenticating phosphorescent stamps or labels in accordance with the present invention may include several useful features. The application may be used and is highly reliable in any lighting environment, including total darkness. The application may be implemented and operated by the user's touch through the smartphone's touch-sensitive screen. Alternatively, the application may be configured for visually impaired users or for voice controlled functionality and audible reporting. In particular, the application may be operated by a user based on voice controlled instructions recognized by the smartphone application and obtained through the smartphone's microphone. The result or determination by the smartphone of the authentication of items with phosphorescent stamps or labels may be reported or stated audibly to the user through the application by operation of the smartphone's speaker.

In embodiments such as using a smartphone application for authenticating items with phosphorescent stamps or labels, the application may be customizable for particular solutions. For example, the application may be customized with a queueing feature to contact or communicate with a central authority's website, such as a government registry's or industrial certification organization's website, using remote communication services, such as cellular service or wireless services over the Internet. Such contact or communications between the user's smartphone and the central authority may be conducted in real time to provide accurate authentication and reporting information.

Further, the smartphone application for authenticating and denominating items with phosphorescent stamps or labels may obtain location information using the smartphone's global positioning system (GPS) functionality to send a notification or report to a remote central authority of the user's location in the event the application determines an item to be fraudulent or suspect. In this manner, the smartphone application can provide the GPS location of the source of a fraudulent or suspect item with a central authority using remote communication services, such as cellular service or wireless services over the Internet, to provide real-time information regarding the authentication functions so that the central authority may conduct an immediate investigation into the source of the fraudulent or suspect item.

According to certain exemplary embodiments of the present invention, the exemplary phosphorescent label may also have a tamper resistant feature. For example, the phosphorescent label may be configured such that after the phosphorescent material is adhered to a surface, an individual may be prevented from detaching the phosphorescent material and/or the phosphorescent label in a manner that maintains the integrity of the phosphorescent material and/or the phosphorescent label. For example, any of phosphorescent labels 100, 110, 200, or 210 may be configured such that the label may not be removed intact such that if an individual were to tamper with the label, it would render the phosphorescent label inoperable or create a clear visual indication that the phosphorescent label had been tampered with.

The embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of this disclosure. For a better understanding of the invention, its operating advantages and the specific objects attained by its uses, reference should be had to the accompanying drawings and descriptive matter in which there are illustrated exemplary embodiments of the invention.

1. A system for authenticating an item including a substrate, the system comprising:
a phosphorescent material disposed on or in the substrate and capable of emitting radiation upon excitation by ambient electromagnetic radiation; and
a photoauthentication device capable of being disposed in contact with the substrate, the photoauthentication device comprising a camera configured to detect or measure the emitted radiation;
wherein, in connection with detecting or measuring the emitted radiation, the photoauthentication device is in static contact with the substrate and the camera is disposed over a portion of the phosphorescent material emitting the emitted radiation;
wherein the photoauthentication device is a smartphone or a tablet; and
wherein the camera of the smartphone or the tablet takes a video and the photoauthentication device analyzes the video to detect or measure a time response of the phosphorescent material emitting the emitted radiation.

2. The system of claim 1, wherein the emitted radiation from the phosphorescent material has a spectral signature and the camera is configured to detect or measure the spectral signature, and wherein the phosphorescent material comprises at least a first phosphorescent material and a second phosphorescent material.

3. The system of claim 2, wherein the spectral signature includes a spectral intensity at a first wavelength and a spectral intensity at a second wavelength to define a measured code.

4. The system of claim 3, wherein the measured code is compared to a predetermined code to determine authentication.

5. (canceled)

6. The system of claim 1, wherein the camera of the smartphone or the tablet communicates with a display of the smartphone or the tablet such that visible radiation of the emitted radiation is visible on the display.

7. (canceled)

8. The system of claim 1, wherein the camera communicates with an application to verify the authenticity of the item.

9. The system of claim 1, wherein a light source on the smartphone or the tablet further includes a light source for generating the ambient electromagnetic radiation.

10. The system of claim 1, wherein the phosphorescent material has a decay time, and the camera operates in the video mode to detect or measure the emitted radiation over at least a portion of the decay time when the photoauthentication device is disposed over the portion of the phosphorescent material emitting the emitted radiation to block the ambient electromagnetic radiation.

11. The system of claim 10, wherein the emitted radiation from the phosphorescent material has a spectral signature and the spectral signature includes spectral intensities for a first wavelength and a second wavelength at a first time in the decay time and spectral intensities for the first wavelength and the second wavelength at a second time in the decay time.

12. The system of claim 1, further comprising an ultraviolet radiation absorber combined with the phosphorescent material, wherein the ultraviolet absorber avoids or prevents detection of the emitted radiation from the phosphorescent material by an ultraviolet radiation source.

13. The system of claim 1, wherein the phosphorescent material is disposed in a fiber or planchette embedded in the substrate.

14. The system of claim 1, wherein the substrate is disposed on or in the item or a label on the item.

15. A method for authenticating an item including a substrate, comprising:
irradiating the substrate with ambient electromagnetic radiation, the substrate comprising a phosphorescent material configured to emit radiation upon excitation by the ambient electromagnetic radiation; and
detecting or measuring, with a camera of a photoauthentication device, the emitted radiation from the phosphorescent material;
wherein, in connection with detecting or measuring the emitted radiation, the photoauthentication device is in static contact with the substrate and the camera is disposed over a portion of the phosphorescent material emitting the emitted radiation;
wherein the photoauthentication device is a smartphone or a tablet; and
wherein the camera of the smartphone or the tablet takes a video and the photoauthentication device analyzes the video to detect or measure a time response of the phosphorescent material emitting the emitted radiation.

16. The method of claim 15, wherein the emitted radiation from the phosphorescent material has a spectral signature and the camera is configured to detect or measure the spectral signature.

17. The method of claim 15, wherein the phosphorescent material comprises at least a first phosphorescent material and a second phosphorescent material.

18. The method of claim 15, wherein the phosphorescent material has a decay time and further comprising detecting or measuring the emitted radiation over at least a portion of the decay time when the photoauthentication device is disposed over the portion of the phosphorescent material emitting the emitted radiation.

19. A method for authenticating an item including a substrate, comprising:
irradiating the substrate with ambient electromagnetic radiation, the substrate comprising a phosphorescent material configured to emit radiation having a spectral signature with a decay time upon excitation by the ambient electromagnetic radiation; and
detecting or measuring, with a camera of a photoauthentication device, the emitted radiation from the phosphorescent material during the decay time;
generating, with a computing device of the photoauthentication device, a code based on the spectral signature; and
comparing, with the computing device of the photoauthentication device, the code to a predetermined reference code;
wherein, in connection with detecting or measuring the emitted radiation, the photoauthentication device is in static contact with the substrate and the camera is disposed over a portion of the phosphorescent material emitting the emitted radiation when the emitted radiation is detected or measured to block the ambient electromagnetic radiation;
wherein the photoauthentication device is a smartphone or a tablet; and
wherein the camera of the smartphone or the tablet takes a video and the photoauthentication device analyzes the video to detect or measure a time response of the phosphorescent material emitting the emitted radiation.

20. The method of claim 19, wherein the phosphorescent material comprises at least a first phosphorescent material and a second phosphorescent material.
